(19) United States
(12) Patent Application Publication
(10) Pub. No.: US 2016/0104193 A1
(43) Pub. Date: Apr. 14, 2016

(54) UNIVERSAL CROSS-CHANNEL AUDIENCE ADDRESSABILITY

(71) Applicant: LiveIntent, Inc., New York, NY (US)

(72) Inventors: Matthew Rosenbach Keiser, New York, NY (US); Jerome Charles Sandoval, New York, NY (US)

(21) Appl. No.: 14/874,103

(22) Filed: Oct. 2, 2015

Related U.S. Application Data
(60) Provisional application No. 62/062,070, filed on Oct. 9, 2014.

(51) Int. Cl. G06Q 30/02; H04L 12/58

(52) U.S. Cl. CPC G06Q 30/0251; H04L 51/36

(57) ABSTRACT

An addressability module provides an email template to a publisher for sending an email to a recipient, wherein the email template associates an identifier of the recipient with a content link in the email, and wherein the content link is associated with a content landing page. The addressability module receives a call from the content landing page requesting a creative for display on the content landing page, wherein the call comprises the identifier of the recipient, the identifier having been passed from the email to the content landing page upon selection of the content link by the recipient and identified from the content landing page. The addressability module selects a creative from an advertiser, wherein the creative is targeted to the recipient of the email who is identified by the received identifier, and serves the selected creative for display on the content landing page.

### RELATED APPLICATIONS

This application claims the benefit of U.S. Provisional Application 62/062,070, filed Oct. 9, 2014, the entire contents of which are hereby incorporated by reference herein.

### TECHNICAL FIELD

This disclosure relates to the field of on-line advertising, including customer relationship management, marketing automation and lead management, and, in particular, to cross-channel audience addressability.

### BACKGROUND

Much on-line media content is offered to users free of charge and subsidized through on-line advertising. On-line advertising can include advertising messages conveyed using text, logos, animations, videos, photographs or other graphics. Some examples of on-line advertisements include web banners, email messages, frame ads, pop-up ads, floating ads, expanding ads, trick banners, interstitial ads, and text ads. These on-line advertisements can be presented to a user in a variety of ways including on a web-page, through email, through social media applications, or on a mobile device.

### BRIEF DESCRIPTION OF THE DRAWINGS

The present disclosure is illustrated by way of example, and not by way of limitation, in the figures of the accompanying drawings.

FIG. 1 is a block diagram illustrating an exemplary network architecture in which embodiments of the present disclosure may be implemented.

FIG. 2 is a block diagram illustrating an addressability module, according to some embodiments.

FIG. 3 is a flow diagram illustrating a method for audience addressability, according to some embodiments.

FIG. 4 is a flow diagram illustrating a method for audience addressability, according to some embodiments.

FIG. 5 is a block diagram illustrating an exemplary computer system, according to some embodiments.

### DETAILED DESCRIPTION

Embodiments are described for cross-channel audience addressability. In modern email systems, the recipient of an email can be identified by their email address or by some other unique identifier, such as an encrypted hash of their email address. Since email addresses change infrequently compared to other forms of user identification such as browser cookies, the email address or encrypted hash of the address provides a deterministic identifier of the email recipient that can be used for personalization and targeting. This identification, along with any known personalization or targeting information, may be passed from the email to a content landing page for an advertisement. This allows for higher quality, persistent personalization and targeting beyond the initial email, and onto the landing and future pages of an advertiser website. For example, the recipient may receive an email from a publisher than includes one or more content links directed to a content landing page (e.g., a webpage). When the user clicks or otherwise selects one of the content links in a received email, the user may be directed to the corresponding URL where the content resource is located (e.g., a content landing page). The email system may have the ability to pass the identifier of the user and available targeting data from first, second, and third party sources, along with the URL address through to the landing page. In this manner, the landing page is able to identify users viewing the content and improve targeting or personalization performance even if the user is not logged into the website or browser, or if cookies are unavailable or not functioning for some reason.

Knowing which user is viewing a given content landing page and related targeting data from multiple sources (e.g., the email and previous visits to the site) enables numerous features, such as tracking what content is being viewed at what frequency by users, alignment with the advertiser's marketing funnel and provides the ability to better target or personalize content and advertisements to particular users. In one embodiment, the content landing page may have one or more ad slots designed to display creatives from advertising campaigns. In one embodiment, upon loading, the landing page may make an ad call to an ad server for a creative to be displayed. Since the landing page has the identifier of the user and targeting data, it can pass that identifier and targeting data to the ad server along with the ad call. In one embodiment, the ad server, or some other intermediary server, can select creatives that are personalized or targeted to the specific user and serve those creatives back to the landing page for display. The targeted creatives may be selected based on such information about the user, such as known interests of the user, demographic information of the user, a history of purchases or clicks of the user, or recent context from the email that launched the display, etc. Additional details of this cross-channel audience addressability are provided below.

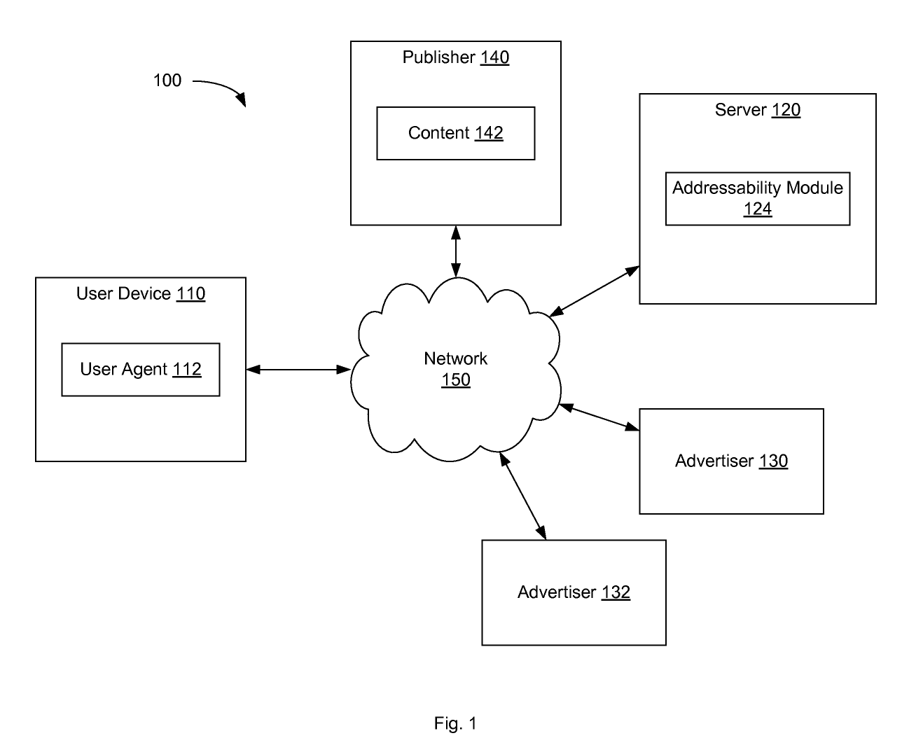

FIG. 1 is a block diagram illustrating an exemplary network architecture in which embodiments of the present disclosure may be implemented. The network architecture 100 can include one or more user devices 110 communicating with one or more servers, such as server 120 over one or more networks 150, according to one embodiment. Network 150 can be a local area network (LAN), a wireless network, a telephone network, a mobile communications network, a wide area network (WAN), such as the Internet, or similar communication system. User device 110 may be any type of computing device including a, desktop computer, laptop computer, mobile communications device, cell phone, smart phone, hand-held computer, tablet computer, or similar computing device. User device 110 may be variously configured with different features to enable viewing of multimedia content, such as images, videos, songs, etc., webpages, email, or other content.

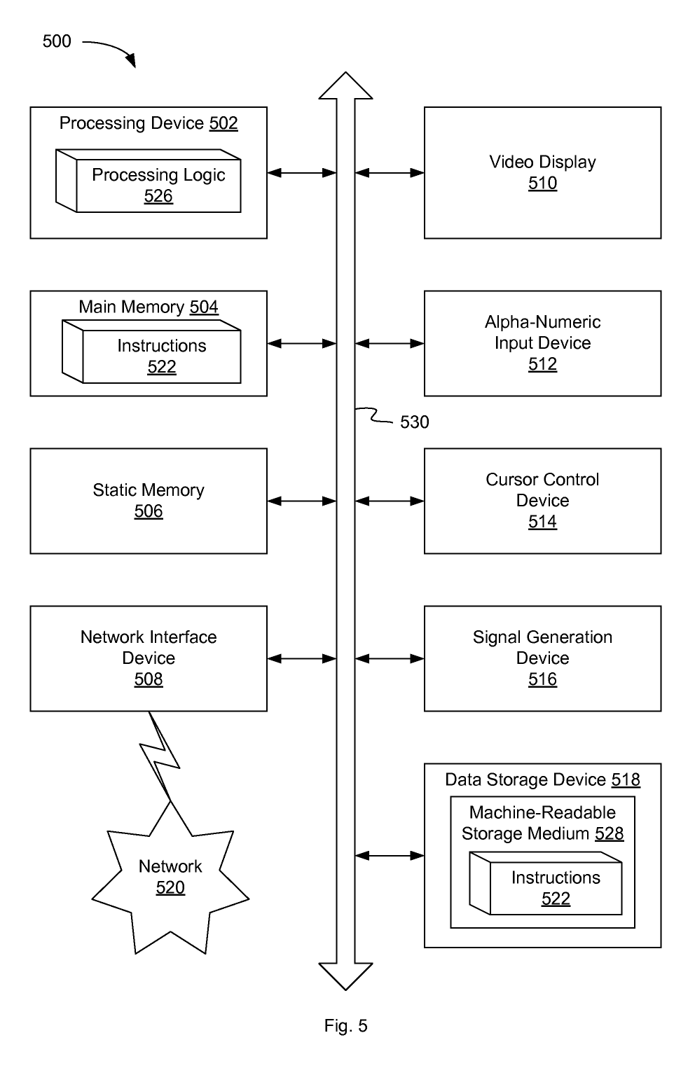

Server 120 may include a network-accessible server-based functionality, various data stores, and/or other data processing equipment. Servers 120 may be implemented by a single machine or a cluster of machines. Server 120 may be hosted, for example, by computer system 500 of FIG. 5. In one embodiment, server 120 hosts web pages. Server 120 can deliver web pages to user device 110 or another client device using for example the Hypertext Transfer Protocol (HTTP). In another embodiment, server 120 may be an email server that delivers emails to user device 110. In another embodiment, server 120 may be an advertising server that delivers advertisements to user device 110.

For example, a user of user device 110 can view an email sent by a publisher 140, using a web browser, email client application or other program running on user device 110. Collectively, the program used to view content on user device 110 may be referred to as user agent 112.

In one embodiment, server 120 also includes addressability module 124. Addressability module 124 can provide an email template to publisher 140 for sending an email to a recipient using user agent 112 on user device 110. In one embodiment, the email template associates an identifier of the recipient and other related targeting data with a content link in the email. The content link may be part of content 142 provided by the publisher (e.g., a link to a news story hosted on a webpage). The identifier may be for example, the email address of the recipient or a hash of the email address of the recipient. The content link may be associated with a content landing page (e.g., a webpage). In one embodiment, addressability module 124 receives a call from the content landing page requesting a creative for display on the content landing page. In one embodiment, the call includes the identifier of the recipient. The identifier may have been passed from the email to the content landing page upon selection of the content link by the recipient. Javascript on the content page or some other tag manager (e.g., Google Tag Manager) may check the URL of the content landing page to see if there is an associated identifier of the user who selected the email content link. If the URL contains an identifier, the identifier may be stripped from the URL and hashed into an MD5 hash. The MD5 hash may be inserted into a tag associated with an advertising slot on the content landing page. When the content landing page makes an ad call for a creative for that slot, the tag (including the identifier of the email recipient) is sent to addressability module 124. The tag is a set of name-value pairs within the HTML representing parameters and their values, e.g., “m=md5hash for user, t=topics recently visited”.

In another embodiment, rather than providing an entire email template to publisher 140, addressability module 124 provides publisher 140 with tags that can be associated with any ad slot, content slot or content link in the email, regardless of the layout. When the links included by publisher 140 have the proper fields appended, including the tag provided by addressability module 124, addressability module 124 can track the recipient of the email back to the content landing page associated with the link and allow for targeted advertisements and content on the content landing page.

In one embodiment, addressability module 124 selects a creative from an advertiser 130 or 132 that is targeted to the recipient of the email, who is identified by the received identifier. For example, this may include a yield optimization process to determine a creative that will result in a highest payout (yield, conversion rate, etc.) to the publisher 140 based on the identity, context, and other data associated with the recipient. In another embodiment, the received identifier may be used to provide improved personalization of content and creatives to improve the user experience and increase the likelihood of the user progressing through the marketing funnel. The marketing funnel may represent the progress a user makes towards the ultimate purchase of a product or service including, for example, the user becoming aware of the existence of the product or service, the user developing an interest in the product or service, the user forming a desire to obtain the product or service and the user taking action towards purchasing the product or service. Information about the recipient may be factored into the creative selection, such as known interests of the recipient, demographic information of the recipient, history of purchases or clicks of the recipient, etc. Addressability module 124 may then serve the selected creative for display to the recipient on the content landing page. Some embodiments of addressability module 124 are discussed in more detail below.

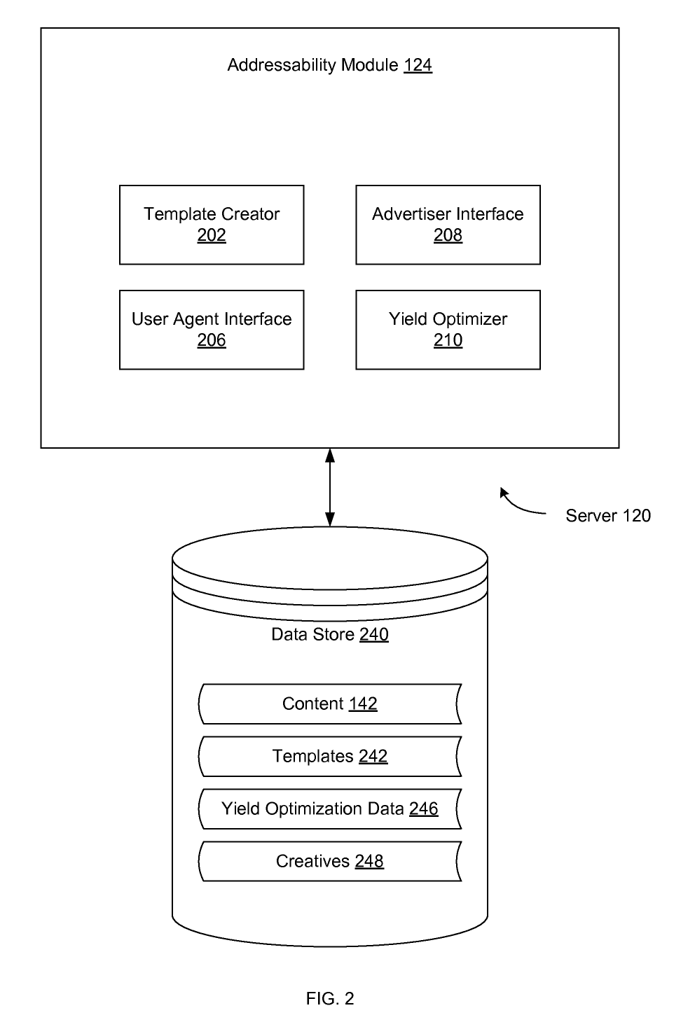

FIG. 2 is a block diagram illustrating addressability module 124, according to some embodiments of the present disclosure. In one embodiment, addressability module 124 includes template creation interface 202, user agent interface 206, advertiser interface 208, and yield optimizer 210. This arrangement of modules may be a logical separation, and in other embodiments, these modules or other components can be combined together or separated in further components, according to a particular embodiment. In one embodiment, storage device 240 is connected to future decisioning module 124 and includes content 142, templates 242, yield optimization data 246, and creatives 248. In one embodiment, server 120 may include addressability module 124 and storage device 240. In another embodiment, storage device 240 may be external to server 120 and may be connected to server 120 over a network or other connection. In other embodiments, server 120 may include different and/or additional components which are not shown to simplify the description. Storage device 240 may include one or more mass storage devices which can include, for example, flash memory, magnetic or optical disks, or tape drives; read-only memory (ROM); random-access memory (RAM); erasable programmable memory (e.g., EPROM and EEPROM); flash memory; or any other type of storage medium.

In one embodiment, template creator 202 provides a template creation interface to allow for the creation of an advertisement template 242. The template creation interface allows a publisher 140 to define the number, location, size, etc. of slots in the template 242. Slots may be for advertisements, content, or content links (e.g., hyperlinks that direct the user to a corresponding content landing page). The template creation interface may be, for example, a graphical user interface (GUI), a command line interface, or some other type of interface. Template creator 202 may provide the template creation interface to publisher 140 and receive instructions to create a template 242 from the publisher 140 defining the layout of slots in the template 242. Template creator 202 may store the template 242 in data store 240 and may associate the template 242 with a piece of content 142 at the request of publisher 140. In one embodiment, template creator 202 includes code or instructions (e.g., macros) in the template 242 that will cause an identifier of the email recipient to be associated with each content link in the template 242. Thus, when the email is sent to the recipient by the publisher, an identifier such as the recipient's email address or a hash of the email address may be appended to each content link. When the recipient receives the email and clicks on one of the content links, the identifier and any associated targeting data from first, second, or third party sources may be passed through to the content landing page.

User agent interface 206 may receive an ad call from the user agent 112 requesting a creative for a first ad slot on the content landing page. In response, user agent interface 206 can notify advertiser interface 208 and yield optimizer 210 in order to select a creative from an advertiser 130, 132 that is personalized or targeted to the recipient of the email and who is now viewing the content landing page. Since the identifier of the email recipient was passed to the content landing page, the ad call from user agent 112 may include the identifier. User agent interface 206 can provide that identifier to the other modules for use in selecting the creative.

In one embodiment, advertiser interface 208 generates bid requests for the advertisement slot (or for multiple slots) on the content landing page. Advertiser interface 208 may send the bid requests to advertisers 130 and 132, thereby initiating an auction for the ad slot. In response to the bid requests, advertiser interface 208 may receive responses to the bid requests including prices the advertisers 130 and 132 are willing to pay for each ad slot, how may ad slots they wish to purchase, etc. The prices may be defined on a cost per mille (CPM) basis, calculated using a click-through rate, a conversional goal, or some other metric.

In one embodiment, yield optimizer 210 performs a yield optimization based on the responses to the bid requests to determine creatives 248 for the ad slot that will maximize a payout to the publisher 140. In one embodiment, the yield may be affected by such factors as the price an advertiser is willing to pay, how many ad slots an advertiser is willing to purchase, how many advertisers are willing to purchase a given slot, the basis on which the cost is defined, or other factors. Yield optimizer 210 may perform calculations based on these factors and store the results as yield optimization data 246. Based on the yield optimization, and on the identifier of the email recipient user agent interface 206 may select creatives 248 provided by advertisers 130 and 132 that are targeted to the email recipient and serve those creative 248 to user agent 112 to be displayed in the designated ad slots of the content landing page along with the piece of content 142 provided by publisher 140.

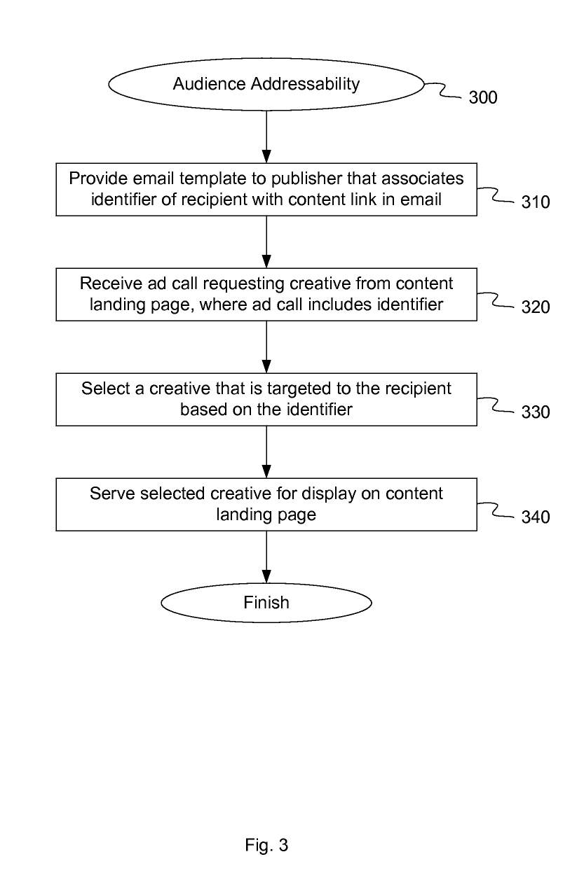

FIG. 3 is a flow diagram illustrating a method for audience addressability, according to some embodiments. The method 300 may be performed by processing logic that comprises hardware (e.g., circuitry, dedicated logic, programmable logic, microcode, etc.), software (e.g., instructions run on a processing device to perform hardware simulation), or a combination thereof. The method 300 can allow for tracking of an individual user from an email to a content landing page in order to provide targeted advertising to the individual on the content landing page. In one embodiment, method 300 may be performed by addressability module 124, as shown in FIGS. 1 and 2.

Referring to FIG. 3, at block 310, method 300 provides an email template to a publisher for sending an email to a recipient. In one embodiment, the email template associates an identifier of the recipient with a content link in the email. The content link may be associated with a content landing page. In one embodiment, the template includes code or instructions (e.g., macros) that will cause the identifier of the email recipient to be associated with each content link in the template. Thus, when the email is sent to the recipient by the publisher, the identifier such as the recipient's email address or a hash of the email address may be appended to each content link. When the recipient receives the email and clicks on one of the content links, the identifier and associated targeting data may be passed through to the content landing page.

At block 320, method 300 receives an ad call from the content landing page requesting a creative for display on the content landing page. In one embodiment, the ad call comprises an identifier of the recipient, where identifier and targeting data was passed from the email to the content landing page upon selection of the content link by the recipient. The identifier may be identified from the content landing page and included in the received ad call. Since the identifier of the email recipient was passed to the content landing page, the ad call from user agent 112 may include the identifier. User agent interface 206 can provide that identifier to the other modules for use in selecting the creative.

At block 330, method 300 selects a creative from an advertiser to be displayed on the content landing page. In one embodiment, the creative is targeted to the recipient of the email, who is identified by the identifier received in the ad call. In one embodiment, yield optimizer 210 may use demographic information about the user, user history information, context, targeting data, information about the content on the content landing page or other information to select a targeted creative or multiple creative to display on the content landing page. Yield optimizer 210 may also consider the price a given advertiser is willing to pay, how many ad slots an advertiser is willing to purchase, how many advertisers are willing to purchase a given slot, the basis on which the cost is defined, or other factors in selecting the creative. At block 340, method 300 serves the selected creative for display on the content landing page.

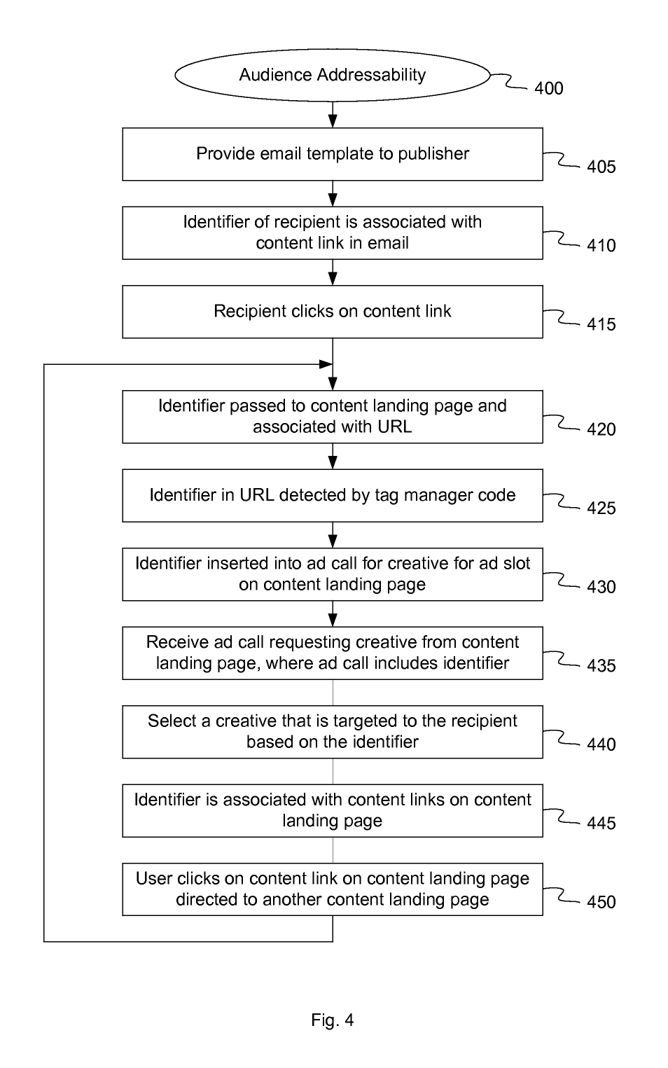

FIG. 4 is a flow diagram illustrating a method for audience addressability, according to some embodiments. The method 400 may be performed by processing logic that comprises hardware (e.g., circuitry, dedicated logic, programmable logic, microcode, etc.), software (e.g., instructions run on a processing device to perform hardware simulation), or a combination thereof. The method 400 can allow for tracking of an individual user from an email to a content landing page in order to provide targeted advertising to the individual on the content landing page. In one embodiment, method 400 may be performed by addressability module 124, user agent 112 and publisher 140, as shown in FIGS. 1 and 2.

Referring to FIG. 4, at block 405, method 400 provides an email template to a publisher for sending an email to a recipient. The email template may include ad slots, content slots and/or content links. When selected, the content links may direct the recipient or user to a content landing page.

At block 410, the identifier of the recipient is associated with a content link in the email. In one embodiment, the email template associates an identifier of the recipient with a content link in the email. In one embodiment, the template includes code or instructions (e.g., macro expansion of content links in a template containing “e={EMAIL}” or “m={MD5_EMAIL}” provided by the sender of the email) that will cause the identifier of the email recipient to be associated with each content link in the template. Thus, when the email is sent to the recipient by the publisher, the identifier such as the recipient's email address or a hash of the email address may be appended to each content link. Similarly, targeting parameters such as “segment=female_30_40” may be passed in the same manner.

At block 415, the recipient clicks on the content link, and at block 420, the identifier is passed to the content landing page and associated with the URL of the content landing page. Depending on the needs of the content landing page, the identifier may be encrypted into a hashed identifier by browser-based JavaScript when the user selects the content link 415. When the recipient receives the email and clicks on one of the content links (or otherwise selects the content link), the identifier may be passed through to the content landing page via URL parameters. In one embodiment, the URL populates a variable in the browser environment with the identifier (e.g., email address or hash). The variables may be key-value pairs appended as URL parameters, e.g., “&e=recipient@domain.com” and “&segment=female_30_40” to the end of the content link.

At block 425, the identifier in the URL is detected by a tag manager code. In one embodiment, Javascript on the content page or some other tag manager (e.g., Google Tag Manager) may check the URL of the content landing page to see if there is an associated identifier and segment information for the user who selected the email content link. If the URL contains an identifier, the identifier may be stripped from the URL and hashed into an MD5 hash via JavaScript functions (e.g., publicly available md5.j s function). Similarly, targeting information may be stripped from the URL and encrypted as needed.

At block 430, the identifier and targeting information is inserted into an ad call for a creative to be displayed in an ad slot on the content landing page. The MD5 hash may be inserted into an E2D LiveTag or other advertising tag associated with an advertising slot on the content landing page. When the content landing page makes an ad call for a creative for that slot, the E2D LiveTag or other advertising tag (including the identifier of the email recipient appended as a key-value appended to the URL) is sent to addressability module 124. Similarly, segmentation information can be appended as a key-value within the URL parameters to be sent to addressability module 124.

At block 435, method 400 receives an ad call from the content landing page requesting a creative for display on the content landing page. In one embodiment, the ad call comprises an identifier of the recipient, where identifier was been passed from the email to the content landing page upon selection of the content link by the recipient. The ad call may also include segment information for the user. The identifier may be identified from the content landing page and included in the received ad call. Since the identifier of the email recipient was passed to the content landing page, the ad call from user agent 112 may include the identifier. User agent interface 206 can provide that identifier and segment information to the other modules for use in selecting the creative.

At block 440, method 400 selects a creative from an advertiser to be displayed on the content landing page using the identifier and segment information. In one embodiment, the creative is targeted to the recipient of the email, who is identified by the identifier received in the ad call. In one embodiment, yield optimizer 210 may use segment or demographic information about the user, user history information, information about the content on the content landing page or other information to select a personalized or targeted creative (or multiple creatives) to display on the content landing page. Yield optimizer 210 may also consider the price a given advertiser is willing to pay, how many ad slots an advertiser is willing to purchase, how many advertisers are willing to purchase a given slot, the basis on which the cost is defined, or other factors in selecting the creative. Yield optimizer 210 may also consider the other content and ad slots on the page as factors in selecting the creative. The selection process in method 440 may combine these data elements toward a variety of goals and associated constraints. In one embodiment, the optimization may identify the creative that maximizes yield from the page while meeting the personalization and targeting constraints of the user. In another embodiment, the optimization may identify the creative that maximizes the likelihood of the user completing steps in the advertiser's marketing funnel based on user history and the identification information. In another embodiment, the optimization may identify the creative that maximizes the user experience, for example, by providing recommendations for additional products that similar users have purchased. In all cases, the optimization may contain common linear programming approaches for mathematical solutions to the optimization problems, or it may contain heuristic approaches that simplify the optimization to provide real time response.

At block 445, the identifier and segment information are associated with content links on the content landing page. In one embodiment, the tag manager includes code or instructions that will cause the identifier of the email recipient to be associated with each content link on the content landing page. Thus, the identifier and segment information may be appended to each content link associated with a different content landing page.

At block 450, the user clicks on a content link on the content landing page that is directed to another content landing page. Method 400 returns to block 420 and repeats the operations at blocks 420-450 for next content landing page.

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 500 may be representative of a user device, such as user device 110, or of a server, such as server 120, running addressability module 124.

The exemplary computer system 500 includes a processing device 502, a main memory 504 (e.g., read-only memory (ROM), flash memory, dynamic random access memory (DRAM) (such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute processing logic 526 for performing the operations and steps discussed herein.

The computer system 500 may further include a network interface device 508. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

The data storage device 518 may include a machine-readable storage medium 528, on which is stored one or more set of instructions 522 (e.g., software) embodying any one or more of the methodologies of functions described herein. The instructions 522 may also reside, completely or at least partially, within the main memory 504 and/or within the processing device 502 during execution thereof by the computer system 500; the main memory 504 and the processing device 502 also constituting machine-readable storage media. The instructions 522 may further be transmitted or received over a network 520 via the network interface device 508.

The machine-readable storage medium 528 may also be used to store instructions to perform a method for audience addressability, as described herein. While the machine-readable storage medium 528 is shown in an exemplary embodiment to be a single medium, the term “machine-readable storage medium” should be taken to include a single medium or multiple media (e.g., a centralized or distributed database, and/or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

In an example audience addressability processing flow, an email is sent using an email template. For example, the email may be a newsletter that is received by the user from a publisher. The email may contain ad slots, content, or content links directed toward a publisher landing page. In one embodiment, Advertiser X targets the user with an advertising campaign. The advertising campaign may include advertisements and other creatives designed to reach customers who have previously expressed interest in the advertiser's product offering or are a target client for the advertiser. The targeted users may be selected using the advertiser's first party customer relationship manager data list and/or other targeting algorithms. The advertising campaign may cost effectively drive a high number of qualified and engaged consumers to the advertiser's web forms. In addition, one or more of the content links in the email may be appended with the user email address or other identifier and targeting data. When the user clicks on a content link, the user lands on the content landing page, and the identifier and targeting data are passed through to the landing page.

The publisher landing page is displayed and may include content, advertising creatives and additional content links directed toward other landing pages. In one embodiment, Javascript checks the URL of the landing page to see if it contains an email or hash identifier. If the URL contains an email, the email is striped and hashed into an MD5 hash. Javascript takes the email hash and inserts it into an E2D LiveTag associated with the ad slot on the landing page. This allows an advertiser to target the user with an advertising campaign or to serve an optimized ad based on the user email hash and targeting data. In addition, the Javascript appends one or more content links on the landing page with a query string containing the email hash. Thus, when a user clicks on a content link, the user lands on the content landing page and the identifier is passed through to the landing page. The processing flow can than continue at that landing page and so on.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

In situations in which the systems discussed herein collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the media server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the web server or media server.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive or.”

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

What is claimed is:

1. A method for a server computer system comprising:
receiving a call from a content landing page requesting a creative for display on the content landing page, wherein the call comprises an identifier of an email recipient and targeting data associated with the recipient, the identifier and targeting data having been passed from an email to the content landing page upon selection of a content link in the email by the recipient and identified from the content landing page;
selecting, by a processing device, a creative from an advertiser, wherein the creative is targeted to the recipient of the email who is identified by the received identifier and targeting data; and
serving the selected creative targeting the email recipient for display on the content landing page.

2. The method of claim 1, further comprising:
providing an email template to a publisher for sending the email to the recipient, wherein the email template associates the identifier of the recipient and the targeting data with the content link in the email, wherein the content link is associated with the content landing page.

3. The method of claim 1, wherein the identifier and targeting data are appended to a uniform resource locator (URL) of the content link.

4. The method of claim 1, wherein the identifier comprises an email address of the recipient.

5. The method of claim 1, wherein the identifier comprises a hash of an email address of the recipient.

6. The method of claim 1, wherein the idenfitier comprises personalization information corresponding to the recipient.

7. The method of claim 1, wherein selecting the creative comprises:
generating a bid request;
receiving, from one or more bidders, responses to the bid request; and
performing a yield optimization based on the responses to the bid request to maximize a payout or value for the creative.

8. A system comprising:
a memory; and
a processing device operatively coupled to the memory, the processing device to:
receive a call from a content landing page requesting a creative for display on the content landing page, wherein the call comprises an identifier of an email recipient and targeting data associated with the recipient, the identifier and targeting data having been passed from an email to the content landing page upon selection of a content link in the email by the recipient and identified from the content landing page;
select a creative from an advertiser, wherein the creative is targeted to the recipient of the email who is identified by the received identifier and targeting data; and
serve the selected creative targeting the email recipient for display on the content landing page.

9. The system of claim 8, wherein the processing device further to:
provide an email template to a publisher for sending the email to the recipient, wherein the email template associates the identifier of the recipient and the targeting data with the content link in the email, wherein the content link is associated with the content landing page.

10. The system of claim 8, wherein the identifier and targeting data are appended to a uniform resource locator (URL) of the content link.

11. The system of claim 8, wherein the identifier comprises an email address of the recipient.

12. The system of claim 8, wherein the identifier comprises a hash of an email address of the recipient.

13. The system of claim 8, wherein the idenfitier comprises personalization information corresponding to the recipient.

14. The system of claim 8, wherein to select the creative, the processing device to:
generate a bid request;
receive, from one or more bidders, responses to the bid request; and
perform a yield optimization based on the responses to the bid request to maximize a payout or value for the creative.

15. A non-transitory computer-readable storage medium storing instructions which, when executed, cause a processing device to perform operations comprising:
receiving a call from a content landing page requesting a creative for display on the content landing page, wherein the call comprises an identifier of an email recipient and targeting data associated with the recipient, the identifier and targeting data having been passed from an email to the content landing page upon selection of a content link in the email by the recipient and identified from the content landing page;
selecting, by the processing device, a creative from an advertiser, wherein the creative is targeted to the recipient of the email who is identified by the received identifier and targeting data; and
serving the selected creative targeting the email recipient for display on the content landing page.

16. The non-transitory computer-readable storage medium of claim 15, the operations further comprising:
providing an email template to a publisher for sending the email to the recipient, wherein the email template associates the identifier of the recipient and the targeting data with the content link in the email, wherein the content link is associated with the content landing page.

17. The non-transitory computer-readable storage medium of claim 15, wherein the identifier and targeting data are appended to a uniform resource locator (URL) of the content link.

18. The non-transitory computer-readable storage medium of claim 15, wherein the identifier comprises an email address of the recipient.

19. The non-transitory computer-readable storage medium of claim 15, wherein the identifier comprises a hash of an email address of the recipient.

20. The non-transitory computer-readable storage medium of claim 15, wherein selecting the creative comprises:
generating a bid request;
receiving, from one or more bidders, responses to the bid request; and
performing a yield optimization based on the responses to the bid request to maximize a payout or value for the creative.
